(19) United States
(12) Patent Application Publication
(10) Pub. No.: US 2025/0045439 A1
(43) Pub. Date: Feb. 6, 2025

(54) EXPLAINABLE MACHINE LEARNING BASED ON TIME-SERIES TRANSFORMATION

(71) Applicant: EQUIFAX INC., Atlanta, GA (US)

(72) Inventor: Stephen Miller, Guiseley (GB)

(21) Appl. No.: 18/717,263

(22) PCT Filed: Dec. 8, 2021
(86) PCT No.: PCT/US2021/072813

§ 371 Date: Jun. 6, 2024

(51) Int. Cl. G06F 21/62; G06F 17/40

(52) U.S. Cl. CPC G06F 21/6218; G06F 17/40

(57) ABSTRACT

Various aspects involve explainable machine learning based on time-series transformation. For instance, a computing system accesses time-series data of a predictor variable associated with a target entity. The computing system generates a first set of transformed time-series data instances by applying a first family of transformations on the time-series data. Any non-negative linear combination of the first family of transformations forms an interpretable transformation of the time-series data. The computing system determines a risk indicator for the target entity indicating a level of risk associated with the target entity by inputting the first set of transformed time-series data instances into a machine learning model. The computing system transmits, to a remote computing device, a responsive message including the risk indicator. The risk indicator is usable for controlling access to one or more interactive computing environments by the target entity.

### TECHNICAL FIELD

The present disclosure relates generally to machine learning and artificial intelligence. More specifically, but not by way of limitation, this disclosure relates to machine learning based on transformed time-series data for assessing risks or performing other operations and for providing explainable outcomes associated with these outputs.

### BACKGROUND

In machine learning, various models (e.g., artificial neural networks) have been used to perform functions such as providing a prediction of an outcome based on input values. However, existing models evaluate the relationship between the input variables and output by using values of the input variables at a single time point. Input variables typically have values changing over time. By only evaluating the output using input variables at a given time point, these static models do not fully utilize the information contained in the input variables. As a result, the prediction output may not be accurate.

### SUMMARY

Various aspects of the present disclosure provide systems and methods for generating an explainable machine learning model based on transformed time-series data for risk assessment and outcome prediction. In one example, a method that includes one or more processing devices performing operations includes accessing time-series data of a predictor variable associated with a target entity, the time-series data comprising data instances of the predictor variable at a sequence of time points; generating a first set of transformed time-series data instances by applying a first family of transformations on the time-series data; generating a second set of transformed time-series data instances by applying a second family of transformations on the time-series data; determining a risk indicator for the target entity indicating a level of risk associated with the target entity by inputting at least the first set of transformed time-series data instances and the second set of transformed time-series data instances into a machine learning model, wherein the machine learning model determines the risk indicator based on transformed time-series data instances such that a monotonic relationship exists between each transformed time-series data instance and the risk indicator; and transmitting, to a remote computing device, a responsive message including the risk indicator that is usable for controlling access to one or more interactive computing environments by the target entity.

In another example, a system includes a processing device and a memory device in which instructions executable by the processing device are stored for causing the processing device to perform operations. The operations include accessing time-series data of a predictor variable associated with a target entity, the time-series data comprising data instances of the predictor variable at a sequence of time points; generating a first set of transformed time-series data instances by applying a first family of transformations on the time-series data; generating a second set of transformed time-series data instances by applying a second family of transformations on the time-series data; determining a risk indicator for the target entity indicating a level of risk associated with the target entity by inputting at least the first set of transformed time-series data instances and the second set of transformed time-series data instances into a machine learning model, wherein the machine learning model is configured to determine the risk indicator based on transformed time-series data instances such that a monotonic relationship exists between each transformed time-series data instance and the risk indicator; and transmitting, to a remote computing device, a responsive message including the risk indicator, wherein the risk indicator is usable for controlling access to one or more interactive computing environments by the target entity.

In yet another example, a non-transitory computer-readable storage medium having program code that is executable by a processor device to cause a computing device to perform operations. The operations include accessing time-series data of a predictor variable associated with a target entity, the time-series data comprising data instances of the predictor variable at a sequence of time points; generating a first set of transformed time-series data instances by applying a first family of transformations on the time-series data; generating a second set of transformed time-series data instances by applying a second family of transformations on the time-series data; determining a risk indicator for the target entity indicating a level of risk associated with the target entity by inputting at least the first set of transformed time-series data instances and the second set of transformed time-series data instances into a machine learning model, wherein the machine learning model is configured to determine the risk indicator based on transformed time-series data instances such that a monotonic relationship exists between each transformed time-series data instance and the risk indicator; and transmitting, to a remote computing device, a responsive message including the risk indicator, wherein the risk indicator is usable for controlling access to one or more interactive computing environments by the target entity.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which an explainable machine learning model based on transformed time-series data can be trained and applied in a risk assessment application according to certain aspects of the present disclosure.

FIG. 2 is a flow chart depicting an example of a process for generating and utilizing an explainable machine learning model based on transformed time-series data to generate risk indicators for a target entity based on predictor variables associated with the target entity, according to certain aspects of the present disclosure.

FIG. 3 is a diagram depicting an example of the architecture of a neural network that can be generated and optimized according to certain aspects of the present disclosure.

FIG. 4 is a block diagram depicting an example of a computing system suitable for implementing certain aspects of the present disclosure.

### DETAILED DESCRIPTION

Certain aspects described herein are provided for generating an explainable machine learning model based on transformed time-series data for risk assessment and outcome prediction. A risk assessment computing system, in response to receiving a risk assessment query for a target entity, can access an explainable risk prediction model trained to generate a risk indicator for the target entity based on transformed time-series predictor variables associated with the target entity. The risk assessment computing system can apply the risk prediction model on the transformed time-series predictor variables to compute the risk indicator. The risk assessment computing system may also generate explanatory data using the risk prediction model to indicate the impact of the predictor variables or the transformed time-series predictor variables on the risk indicator. The risk assessment computing system can transmit a response to the risk assessment query for use by a remote computing system in controlling access of the target entity to one or more interactive computing environments. The response can include the risk indicator and the explanatory data.

For example, the risk prediction model can be a neural network including an input layer, an output layer, and one or more hidden layers. Each layer contains one or more nodes. Each of the input nodes in the input layer is configured to take values from input data instances. In some examples, the input data instances are transformed time-series data instances. The transformed time-series data instances can be generated from time-series data instances of a predictor variable. The time-series data instances of a predictor variable can contain different values of the predictor variable at different time points. For example, if the predictor variable describes the amount of available storage space of a computing device, a time-series data of the predictor variable can include 30 instances each representing the available storage space at 5:00 pm on each day for 30 consecutive days. The time-series data of the predictor variable captures the changes of the predictor variable over time.

To generate the input data for the prediction model, the time-series data instances can be transformed in different ways to capture different characteristics of the time-series data. Families of time-series data transformations can be selected such that any non-negative linear combination of the transformations forms an interpretable transformation of the time-series data that is justifiable as a model effect. For example, the transformations can be performed using a family of linear transformations. An example of the linear transformations can be transformations enforcing a recency bias on the time-series data. This family of transformations is configured to apply a higher weight on more recent time-series data instances than older data instances. A family of these linear transformations can include transformations that apply different sets of weights and different time windows during the transformation. Another example of linear transformation includes transformations obtaining trends in the time-series data instances. For example, the transformations can be configured to apply a linear regression on the time-series data instances to determine the slope (and intercept) of the regression line as the trend. A family of these linear transformations can include transformations applying the linear regression on different time windows of time-series data instances.

Non-linear transformations can also be applied to the time-series data instances to obtain the input to the model. An example of the non-linear transformations includes variance transformations configured to capture non-directional characteristics in the time-series data instances. A family of variance transformations can include variance transformations applied on different time windows of time-series data instances.

Multiple families of linear or non-linear transformations can be applied on the time-series data instances of a predictor variable to generate multiple sets of transformed time-series data instances. Transformations that combine different families of transformations can also be generated and utilized to transform time-series data instances. Selection of the transformations can be based on factors such as the type of the model, the nature of the predictor variables, the size, or scale of the neural network model, and so on. For example, if the trend of the values of a predictor variable is predictive, a family of transformations configured to obtain the data trends can be selected. If the non-directional characteristics of the time-series data instances of a predictor variable are predictive, a family of variance transformations can be utilized. The transformations selected for different predictor variables can be different.

In some examples, each of the transformed time-series data instances is fed into one input node. The input nodes taking data instances for one family of transformations are connected to one hidden node in the first hidden layer of the neural network. In these examples, one hidden node of the first hidden layer corresponds to one family of transformations. In other examples, a hidden node in the first hidden layer can accept data from multiple families of transformed time-series data instances. Hidden nodes in the first hidden layers can be connected to the nodes in the second hidden layer which may be further connected to the output layer.

The training of the neural network model can involve adjusting the parameters of the neural network based on transformed time-series data instances of the predictor variables and risk indicator labels. The adjustable parameters of the neural network can include the weights of the connections among the nodes in different layers, the number of nodes in a layer of the network, the number of layers in the network, and so on. The parameters can be adjusted to optimize a loss function determined based on the risk indicators generated by the neural network from the transformed time-series data instances of the training predictor variables and the risk indicator labels. To enforce explainability of the model, the adjustment of the model parameters during the training can be performed under constraints. For instance, a constraint can be imposed to require that the relationship between the input transformed time-series data instances and the output risk indicators is monotonic.

In some aspects, the trained neural network can be used to predict risk indicators. For example, a risk assessment query for a target entity can be received from a remote computing device. In response to the assessment query, transformed time-series data instances can be generated for each predictor variable associated with the target entity. An output risk indicator for the target entity can be computed by applying the neural network to the transformed time-series data instances of the predictor variables. Further, explanatory data indicating relationships between the risk indicator and the time-series data instances of predictor variables or transformed time-series data instances can also be calculated. A responsive message including at least the output risk indicator can be transmitted to the remote computing device.

Certain aspects described herein, which can include operations and data structures with respect to the neural network, can provide a more accurate machine learning model by accepting time-series data instances as input, thereby overcoming the issues identified above. For instance, the neural network presented herein is structured so that a sequence of input variable values at different time points, rather than a single time point, are input to the neural network. Further, by applying transformations of time-series data instances before inputting them to the neural network model allows the neural network to be applied to more predictive data or attributes than the time-series data itself. Different transformations can be employed to identify different characteristics (e.g., trend) from the time-series data instances that are otherwise unavailable to the neural network model. These characteristics provide more information to the neural network model than the time-series data, thereby improving the prediction accuracy of the neural network model. In addition, enforcing the monotonicity between each transformed time-series data instance and the output allows using the same neural network to predict an outcome and to generate explainable reasons for the predicted outcome.

Additional or alternative aspects can implement or apply rules of a particular type that improve existing technological processes involving machine-learning techniques. For instance, to enforce the interpretability of the network, a particular set of rules can be employed in the training of the network. This particular set of rules allow monotonicity to be introduced to the neural network by adjusting the neural network based on exploratory data analysis or as a constraint in the optimization problem involved in the training of the neural network. Some of these rules allow the training of the monotonic neural network to be performed more efficiently without any post-training adjustment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Operations

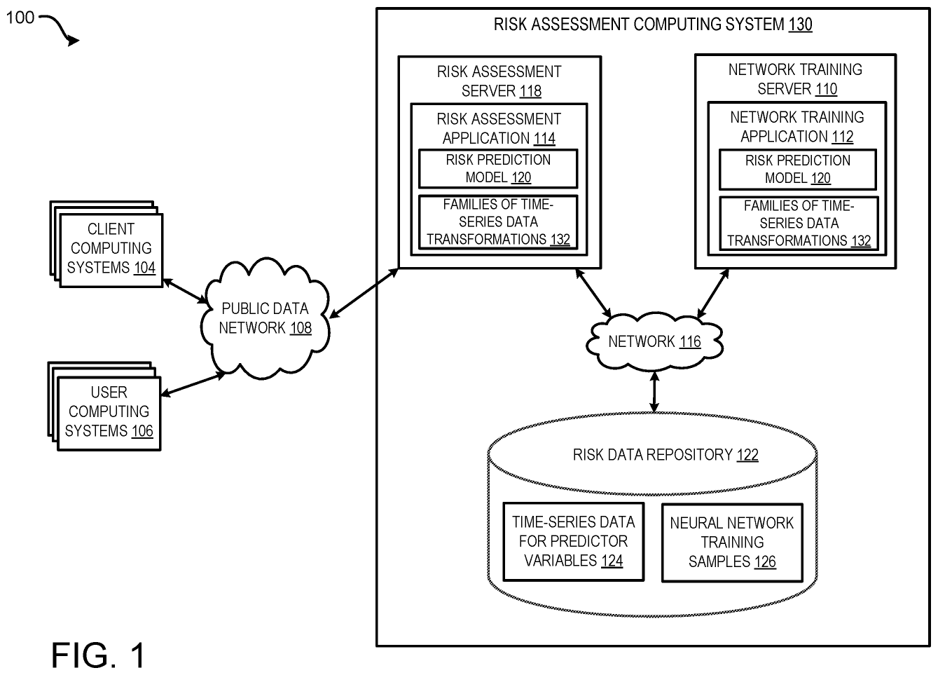

Referring now to the drawings, FIG. 1 is a block diagram depicting an example of an operating environment 100 in which a risk assessment computing system 130 builds and trains a risk prediction model that can be utilized to predict risk indicators based on predictor variables. FIG. 1 depicts examples of hardware components of a risk assessment computing system 130, according to some aspects. The risk assessment computing system 130 can be a specialized computing system that may be used for processing large amounts of data using a large number of computer processing cycles. The risk assessment computing system 130 can include a network training server 110 for building and training a risk prediction model 120 wherein the risk prediction model 120 can be a neural network model with an input layer, an output layer, and one or more hidden layer. The network training server 110 can use families of time-series data transformations 132 to transform training data into transformed training data. The risk assessment computing system 130 can further include a risk assessment server 118 for performing a risk assessment for given time-series data for predictor variables 124 using the trained risk prediction model 120 and the families of time-series data transformations 132.

The network training server 110 can include one or more processing devices that execute program code, such as a network training application 112. The program code can be stored on a non-transitory computer-readable medium. The network training application 112 can execute one or more processes to train and optimize a neural network for predicting risk indicators based on time-series data for predictor variables 124.

In some aspects, the network training application 112 can build and train a risk prediction model 120 utilizing neural network training samples 126. The neural network training samples 126 can include multiple training vectors consisting of training time-series data for predictor variables and training risk indicator outputs corresponding to the training vectors. The neural network training samples 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the network training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

The risk assessment server 118 can include one or more processing devices that execute program code, such as a risk assessment application 114. The program code can be stored on a non-transitory computer-readable medium. The risk assessment application 114 can execute one or more processes to utilize the risk prediction model 120 trained by the network training application 112 to predict risk indicators based on input time-series data for predictor variables 124 transformed using the families of time-series data transformations 132. In addition, the risk prediction model 120 can also be utilized to generate explanatory data for the time-series data for predictor variables 124, which can indicate an effect or an amount of impact that one or more predictor variables have on the risk indicator.

The output of the trained risk prediction model 120 can be utilized to modify a data structure in the memory or a data storage device. For example, the predicted risk indicator and/or the explanatory data can be utilized to reorganize, flag, or otherwise change the time-series data for predictor variables 124 involved in the prediction by the risk prediction model 120. For instance, time-series data for predictor variables 124 stored in the risk data repository 122 can be attached with flags indicating their respective amount of impact on the risk indicator. Different flags can be utilized for different time-series data for predictor variables 124 to indicate different levels of impact. Additionally, or alternatively, the locations of the time-series data for predictor variables 124 in the storage, such as the risk data repository 122, can be changed so that the time-series data for predictor variables 124 or groups of time-series data for predictor variables 124 are ordered, ascendingly or descendingly, according to their respective amounts of impact on the risk indicator.

By modifying the predictor variables 124 in this way, a more coherent data structure can be established which enables the data to be searched more easily. In addition, further analysis of the risk prediction model 120 and the outputs of the risk prediction model 120 can be performed more efficiently. For instance, time-series data for predictor variables 124 having the most impact on the risk indicator can be retrieved and identified more quickly based on the flags and/or their locations in the risk data repository 122. Further, updating the risk prediction model 120, such as re-training the risk prediction model 120 based on new values of the time-series data for predictor variables 124, can be performed more efficiently especially when computing resources are limited. For example, updating or retraining the risk prediction model 120 can be performed by incorporating new values of the time-series data for predictor variables 124 having the most impact on the output risk indicator based on the attached flags without utilizing new values of all the time-series data for predictor variables 124.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 104 to be performed.

In some examples, a client computing system 104 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 104 may be performed through graphical user interfaces presented by the client computing system 104 to the user computing system 106, or through application programming interface (API) calls or web service calls.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. 1 can configure a risk prediction to be used both for accurately determining risk indicators, such as credit scores, using time-series data for predictor variables and determining explanatory data for the predictor variables. A predictor variable can be any variable predictive of risk that is associated with an entity. Any suitable predictor variable that is authorized for use by an appropriate legal or regulatory framework may be used.

Examples of time-series data for predictor variables used for predicting the risk associated with an entity accessing online resources include, but are not limited to, variables indicating the demographic characteristics of the entity over a predefined period of time (e.g., the revenue of the company over the past twenty-four consecutive months), variables indicative of prior actions or transactions involving the entity over a predefined period of time (e.g., past requests of online resources submitted by the entity over the past twenty-four consecutive months, the amount of online resource currently held by the entity over the past twenty-four consecutive months, and so on), variables indicative of one or more behavioral traits of an entity over a predefined period of time (e.g., the timeliness of the entity releasing the online resources over the past twenty-four consecutive months), etc. Similarly, examples of time-series data of predictor variables used for predicting the risk associated with an entity accessing services provided by a financial institute include, but are not limited to, indicative of one or more demographic characteristics of an entity over a predefined period of time (e.g., income, etc.), variables indicative of prior actions or transactions involving the entity over a predefined period of time (e.g., information that can be obtained from credit files or records, financial records, consumer records, or other data about the activities or characteristics of the entity), variables indicative of one or more behavioral traits of an entity over the past twenty-four consecutive months, etc. For example, time-series data for an account balance predictor variable can include the account balance for the past thirty-two consecutive months.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the network training server 110 and the risk assessment server 118, may be instead implemented in a signal device or system.

### Examples of Operations Involving Machine-Learning

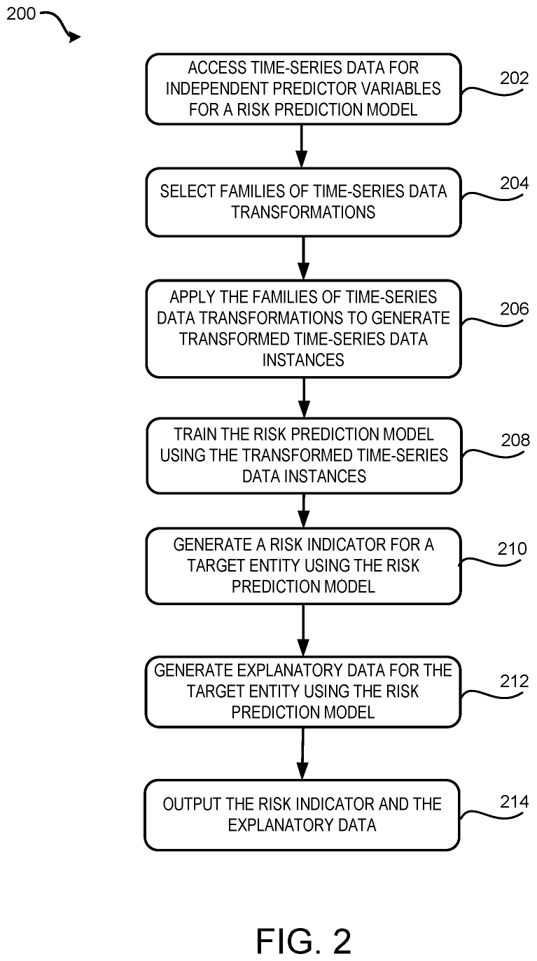

FIG. 2 is a flow chart depicting an example of a process for generating and utilizing an explainable machine learning model based on transformed time-series data to generate risk indicators for a target entity based on predictor variables associated with the target entity, according to certain aspects of the present disclosure. One or more computing devices (e.g., the network training server 110 and the risk assessment server 118) implement operations depicted in FIG. 2 by executing suitable program code (e.g., the network training application 112 and the risk assessment application 114). Blocks 202-208 involves a training process of the explainable machine learning model and blocks 210-214 involves using the explainable machine learning model to perform risk prediction. For illustrative purposes, the process 200 is described with reference to certain examples depicted in the figures. Other implementations, however, are possible.

At block 202, the process 200 involves the network training server 110 accessing time-series data for independent predictor variables for a risk prediction model 120. As described in more detail with respect to FIG. 1 above, examples of predictor variables can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, predictor variables can be obtained from credit files, financial records, consumer records, etc. The time-series data for the predictor variables can be values for the predictor variables of a predefined period of time. For example, the time-series data can be financial records over a twelve month period, behavioral traits over a twelve month period, etc.

At block 204, the process 200 involves the network training server 110 selecting families of time-series data transformations 132. The families of time-series data transformations 132 can be families of linear transformations or families of non-linear transformations. Families of linear transformations can include transformations that linearly combine the time-series data instances. Families of non-linear transformations can include transformations that non-linearly combine the time-series data instances. The families of time-series data transformations 132 can be selected such that any non-negative linear combination of the transformations forms an interpretable transformation of the time-series data that is justifiable as a model effect. Selection of the families of time-series data transformations 132 can be based on factors such as the type of the risk prediction model 120, the nature of the predictor variables, the size, or scale of the risk prediction model 120, and so on. For example, if the time-series data is account balance data over a twenty-four month period, the trend of the values of can be predictive, so a family of transformations configured to obtain the data trends can be selected. If the non-directional characteristics of the time-series data instances of a predictor variable are predictive, a family of variance transformations can be utilized. The family of transformations selected for different predictor variables can be different. An example of the linear transformations includes transformations enforcing a recency bias on the time-series data. This family of transformations is configured so that any non-negative linear combination of the transformations will apply a higher weight on more recent time-series data instances than older data instances. A family of these linear transformations can include transformations that apply different sets of weights and different time windows during the transformation. Another example of linear transformation includes transformations obtaining trends in the time-series data instances. For example, the transformations can be configured to apply a linear regression on the time-series data instances to determine the slope (and intercept) of the regression line as the trend. Additional details regarding the time-series data transformations 132 are provided later.

At block 206, the process 200 involves the network training server 110 applying the families of time-series data transformations 132 to generate transformed time-series data instances. The number of transformed time-series data instances can depend on the families of time-series data transformations and the number of time-series data instances. For example, if the time-series data includes a past-due amount for each of the past thirty-six consecutive months and the family of time-series data transformations enforces the recency bias on the time-series data, the network training server 110 can generate one transformed time-series instance for each time-series data instance, for a total of thirty-six transformed time-series data instances. Multiple families of linear or non-linear transformations can be applied on the time-series data instances of a predictor variable to generate multiple sets of transformed time-series data instances. For example, applying the family of time-series data transformations that enforces the recency bias can generate a first set of transformed time-series data instances, and a second family of time-series data transformations that obtains trends in the time-series data can be applied to generate a second set of transformed time-series data instances.

At block 208, the process 200 involves the network training server 110 training the risk prediction model 120 using the transformed time-series data instances. In some examples, the transformed time-series data instances generated through different families of transformations are correlated. The network training server 110 can reduce the correlation by pre-processing the transformed time-series data instances. For example, the network training server 110 can perform correlation analysis on at least the first family of transformations and the second family of transformations to reduce the correlation. The network training server 110 can also reduce correlation by performing regularization or group least absolute shrinkage and selection operator (LASSO) during the training on at least the first family of transformations and the second family of transformations to reduce the correlation. The training can involve adjusting the parameters of the risk prediction model 120 based on the transformed time-series data instances of the predictor variables and risk indicator labels. The adjustable parameters of the risk prediction model 120 can include the weights of the connections among the nodes in different layers, the number of nodes in a layer of the network, the number of layers in the network, and so on. The parameters can be adjusted to optimize a loss function determined based on the risk indicators generated by the risk prediction model 120 from the transformed time-series data instances of the training predictor variables and the risk indicator labels. To enforce explainability of the risk prediction model 120, the adjustment of the parameters during the training can be performed under constraints. For instance, a constraint can be imposed to require that the relationship between the input transformed time-series data instances and the output risk indicators is monotonic. The trained risk prediction model 120 can be utilized to make predictions.

At block 210, the process 200 involves generating a risk indicator for a target entity using the risk prediction model 120 by, for example, the risk assessment server 118. The risk assessment server 118 can receive a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity. Families of time-series data transformations 132 selected for the risk prediction model 120 can be applied to time-series data for a predictor variable 124. The risk indicator can indicate a level of risk associated with the entity, such as a credit score of the entity.

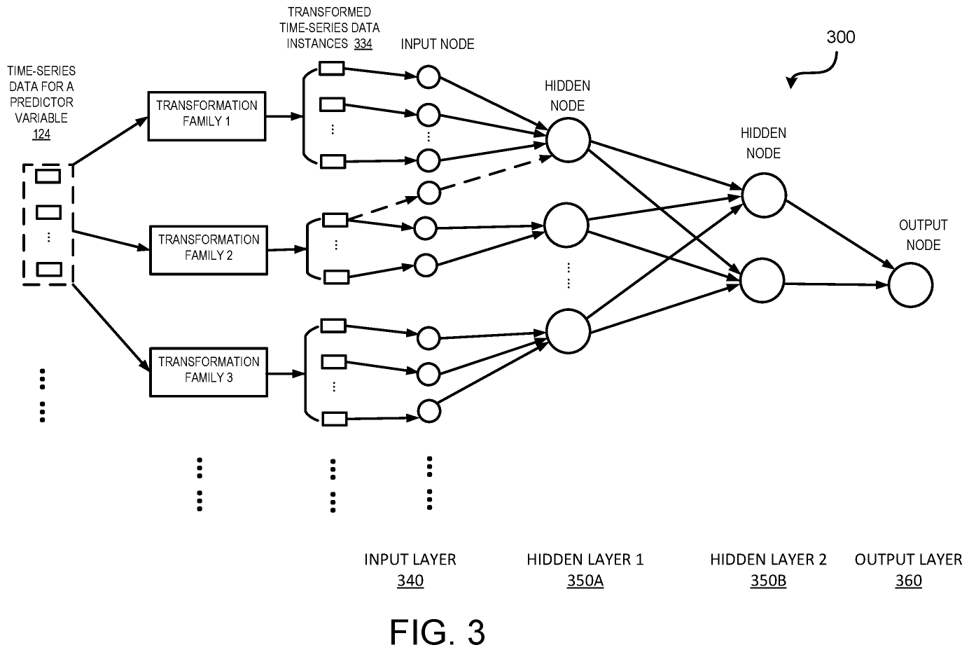

Referring to FIG. 3, which shows an example of the architecture of the risk prediction model 120, the risk prediction model 120 includes an input layer 340, an output layer 360, and hidden layers 350A-B. One or more families of time-series transforms can be applied to the time-series data for a predictor variable 124 to generate transformed time-series data instances 334. Each of the transformed time-series data instances 334 can be fed into one input node of the input layer 340. Input nodes taking data instances for one family of transformations can be connected to one hidden node in the first hidden layer of the risk prediction model 120. In these examples, one hidden node of the first hidden layer 350A corresponds to one family of transformations. In other examples, a hidden node in the first hidden layer 350A can accept data from multiple families of transformed time-series data instances, as illustrated by the dashed line. Hidden nodes in the first hidden layer 350A are connected to the nodes in the second hidden layer 350B, which are further connected to the output layer 360.

Returning to FIG. 2, at operation 212, the process 200 involves the risk assessment server 118 generating explanatory data for the target entity using the risk prediction model 120. The explanatory data can indicate relationships between the time-series data instances of the predictor variable and the output risk indicator or between the transformed time-series data instances and the output risk indicator. The explanatory data may indicate an impact a predictor variable has or a group of predictor variables have on the value of the risk indicator, such as credit score (e.g., the relative impact of the predictor variable(s) on a risk indicator). The explanatory data can be calculated using a points-below-max algorithm or an integrated gradients algorithm. In some aspects, the risk assessment application 114 uses the risk prediction model 120 to provide explanatory data that are compliant with regulations, business policies, or other criteria used to generate risk evaluations. Examples of regulations to which the risk prediction model 120 conforms and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanatory data can be generated for a subset of the predictor variables that have the highest impact on the risk indicator. For example, the risk assessment application 114 can determine the rank of each time-series data instance (or transformed time-series data instance) based on the impact of the time series data instance (or transformed time-series data instance) predictor variable on the risk indicator. A subset of the time-series data instances for the predictor variable including a certain number of highest-ranked time-series data instances predictor variables can be selected and explanatory data can be generated for the selected predictor variables.

At operation 214, the process 200 involves outputting the risk indicator and the explanatory data. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may be implemented to provide interactive computing environments for customers to access various services offered by these service providers. Customers can utilize user computing systems 106 to access the interactive computing environments thereby accessing the services provided by these providers.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate time-series data for predictor variables. The risk assessment server 118 can perform a risk assessment based on time-series data for predictor variables generated for the customer and return the predicted risk indicator and explanatory data to the client computing system 104.

Based on the received risk indicator, the client computing system 104 can determine whether to grant the customer access to the interactive computing environment. If the client computing system 104 determines that the level of risk associated with the customer accessing the interactive computing environment and the associated technical or financial service is too high, the client computing system 104 can deny access by the customer to the interactive computing environment. Conversely, if the client computing system 104 determines that the level of risk associated with the customer is acceptable, the client computing system 104 can grant access to the interactive computing environment by the customer and the customer would be able to utilize the various services provided by the service providers. For example, with the granted access, the customer can utilize the user computing system 106 to access clouding computing resources, online storage resources, web pages or other user interfaces provided by the client computing system 104 to execute applications, store data, query data, submit an online digital application, operate electronic tools, or perform various other operations within the interactive computing environment hosted by the client computing system 104.

The risk assessment application 114 may provide recommendations to a target entity based on the generated explanatory data. The recommendations may indicate one or more actions that the target entity can take to improve the risk indicator (e.g., improve a credit score).

While the above description focuses on inputting transformed time-series data to the risk prediction model, the risk prediction model can also be configured to accept input variables that do not have time-series data instances associated therewith. For example, one of the input nodes of the risk prediction can be configured to accept a prediction variable with a static value (e.g., the age or gender of a consumer).

### Examples of Time-Series Data Transformations Families

Families of transformations take as input time-series data for one or more predictor variables at several equally spaced points in time, indexed relative to an observation time point. The families of transformations output numerical quantities that may be interpreted as summary features of the time series. An example of time-series data for a predictor variable in a credit-risk context is a series of observations of a total revolving balance for a consumer, measured at monthly intervals up to and including the observation date, which is the date at which a lending decision is to be made regarding the consumer. An example transformation is a function that calculates an average of the most recent twelve monthly values. Another example transformation is a function that takes the monthly value exactly five months before the observation point.

Notationally, a time series data can be denoted as X=(xₜ, t≤0) so that the observation point corresponds to t=0 and earlier observations of x correspond to negative values of t. A generic transformation can be denoted as a function ƒ((xₜ)). Examples of the transformations can be linear or polynomial transformations. A linear transformation can take the form:

$$f ( X ) = {\sum }_{t} {a}_{t} {x}_{t} \qquad ( 1 )$$

where the transformation is a linear function of the individual point-in-time time values.

Similarly, a polynomial transformation can take the form:

$$f ( X ) = {\sum }_{t , u} {a}_{t , u} {x}_{t} {x}_{u} \qquad ( 2 )$$

where the sum is over all pairs of time points (t, u). Transformations of higher powers can be similarly defined, and a polynomial transformation of degree n is a linear combination of transformations of powers up to and including n. A linear combination of polynomial transformations is again a polynomial transformation. The transformations can therefore form real valued vector spaces, and sets and bases for the vector spaces of transformations can be generated.

The space of linear transformations on a time series of length T is a vector space of dimension T and is dual to the vector space of the time series of length T. The standard basis for the space of transformations is given by the transformations eₜ*(X)=xₜ, which can be described as “evaluation at time t.” The basis {eₜ*} has the property that any model function F((eₜ*(X)) is monotonically increasing in the basis transformations if and only if it is monotonically increasing in each point-in-time value xₜ.

A family of transformations may enforce a recency bias on the time-series data. Recency bias can be enforced by use of the transformation basis {rⱼ*=Σᵢ₌₀^{-j}eᵢ*} or a re-scaled equivalent such as

$$\{ {s}_{j}^{*} = \frac{1}{j + 1} {\sum }_{i = 0}^{- j} {e}_{i}^{*} \} .$$

A linear transformation can show recency bias if and only if it is monotonic in either of these bases. Any linear transformation that is a non-negative linear combination of the recency bias basis can be interpreted as a weighted average over recent observations with higher weight assigned to more recent time points. Another example of a linear transformation is a family of transformations that obtains trends in time-series data based on a linear regression. The linear regression of the time series X=(xₜ, t≤0) can be performed against t for integer values of t in the range −s≤t≤0. Equations for the slope \hat{β} and intercept \hat{α} of the regression line are:

$$\hat{β} = {\sum }_{t = - s}^{0} {x}_{t} \frac{1}{s + 1} \frac{( t - \overline{t} )}{{s}_{t}^{2}} \qquad ( 3 )$$

$$\hat{α} = {\sum }_{t = - s}^{0} {x}_{t} \frac{1}{s + 1} - \overline{t} \hat{β} = {\sum }_{t = - s}^{0} {x}_{t} [ \frac{1}{s + 1} - \overline{t} \frac{1}{s + 1} \frac{( t - \overline{t} )}{{s}_{t}^{2}} ] \qquad ( 4 )$$

$$where \overline{t} = - \frac{s}{2} and {s}_{t}^{2} = \frac{s ( s + 2 )}{12}$$

are the mean and (unadjusted) variance of the t values respectively. Both of these estimators are linear in the values (xₜ). In particular, the slope or trend estimator \hat{β} is proportional to the transformation

$${b}_{s}^{*} = {\sum }_{t = 0}^{s} ( - t + \frac{s}{2} ) {e}_{t}^{⋆}$$

and the same multiple of the intercept transformation \hat{α} is given by the transformation:

$${a}_{s}^{*} = \frac{s ( s + 2 )}{12} {\sum }_{t = 0}^{s} {e}_{t}^{⋆} + \frac{s}{2} {b}_{s}^{*} = {\sum }_{t = 0}^{s} [ \frac{s ( s + 2 )}{12} + \frac{s}{2} ( - t + \frac{s}{2} ) ] {e}_{t}^{⋆} . \qquad ( 5 )$$

For a fixed s, any positive multiple of bₛ* may be interpreted as capturing the trend in X over the time period −s≤t≤0. A transformation of the form

$$λ {a}_{s}^{*} + γ {b}_{s}^{*} = λ ( {a}_{s}^{*} + \frac{γ}{λ} {b}_{s}^{*} )$$

may be interpreted as capturing a linear projection of X to time

$$u = \frac{γ}{λ} .$$

If u is positive, the transformation is a positive combination of αₛ* and bₛ*, and the transformation may be interpreted as a forward projection. Large values of u, such as higher than twenty four (if t is measured in months), can represent projection into the far future. For a fixed value of u, a transformation of the form λ(αₛ*+ubₛ*)+γαₛ*, with both λ and γ positive, captures a forward projection to time no more than u.

It is not the case that any non-negative linear combination of the non-weighted trend transformations bᵣ* for values r<0 can be re-expressed as a weighted regression with monotonic weights. But any such combination can be explained and justified as a weighted trend or combination of trends. Meanwhile, any positive combination of the non-weighted intercept transformations αᵣ* can be explained as a trend plus a recency-weighted average, or a combination of projections to time t=0. Therefore any positive combination of the non-weighted trend transformations bᵣ* for r<0 and any positive combination of time-limited forward projection transformations λ(αᵣ*+ubᵣ*)+γαᵣ* for r<0 and u>0 fixed can be allowed.

To capture non-directional effects in a time series, such as variance, non-linear transformations, such as quadratic and polynomial transformations, may be used. The variance of the time series X=(xₜ, t≤0) measured over times −s≤t<0 is given by the quadratic formula:

$$\begin{matrix}Var ( {x}_{t} , - s \leq t < 0 ) = \frac{1}{s + 1} {\sum }_{t = - s}^{0} {x}_{t}^{2} - {[ \frac{1}{s + 1} {\sum }_{t = - s}^{0} {x}_{t} ]}^{2} \\ = \frac{s}{{( s + 1 )}^{2}} {\sum }_{t = - s}^{0} {x}_{t}^{2} - \frac{2}{{( s + 1 )}^{2}} {\sum }_{t = - s}^{0} {\sum }_{u \neq t} {x}_{t} {x}_{u} \\ = \frac{1}{{( s + 1 )}^{2}} {v}_{s}^{*} ( X )\end{matrix} \qquad ( 6 )$$

As with the regression trend and intercept transformation, this formula has few degrees of freedom but any positive linear combination of the transformations vᵣ* for r<0 can be fit to explain this as a combination of variance calculations.

Another example of a family of transformations is volatility and mean squared change. The volatility of a time series can be defined, particularly in finance, as a standard deviation of returns over a fixed time window (e.g., daily volatility is calculated from the standard deviation of day-on-day price differences). Given a time series X=(xₜ, t≤0) the squared single-timestep volatility over times −s≤t<0 can be measured using the formula:

$${Vol}^{2} ( {x}_{t} , - s \leq t < 0 ) = Var ( {x}_{t} - {x}_{t - 1} , - s + 1 \leq t < 0 ) = \frac{1}{s} {\sum }_{t = - s + 1}^{0} {( {x}_{t} - {x}_{t - 1} )}^{2} - {[ \frac{1}{s} {\sum }_{t = - s + 1}^{0} ( {x}_{t} - {x}_{t - 1} ) ]}^{2} = \frac{1}{s} {\sum }_{t = - s + 1}^{0} ( {( {x}_{t} - {x}_{t - 1} )}^{2} - {[ \frac{1}{s} ( {x}_{0} - {x}_{- s} ) ]}^{2} \qquad ( 7 )$$

The second term is the square of the overall change in the value of X from t=−s to t=0. This is a coarse measurement of trend. In some examples, the second term can be ignored and the first term can be focused on, which is the mean squared change Ê[(xₜ−xₜ₋₁)²]. The first term can be influenced equally by a positive or negative drift in the time series.

The formula for weighted squared volatility, where weights are applied to the time windows between observations (xₜ−xₜ₋₁) takes the form:

$$( 8 )$$

$$\begin{matrix}{Vol}^{2} ( {x}_{t} , - s \leq r < 0 ) = \frac{1}{{N}_{w}} {\sum }_{t = - s + 1}^{0} {{w}_{t} ( {x}_{t} - {x}_{t - 1} )}^{2} - {[ \frac{1}{{N}_{w}} {\sum }_{t = - s + 1}^{0} {w}_{t} ( {x}_{t} - {x}_{t - 1} ) ]}^{2} \\ = \frac{1}{{N}_{w}} {\sum }_{t = - s + 1}^{0} {{w}_{t} ( {x}_{t} - {x}_{t - 1} )}^{2} + trend term\end{matrix}$$

The weighted mean squared change term is proportional to Σₜ₌₋ₛ₊₁⁰wₜ(xₜ−xₜ₋₁)², so an explainable recency biased weighted mean squared change transformation can be constructed by taking positive linear combinations of the transformations:

$${c}_{s}^{*} = {\sum }_{i = - s}^{- 0} {d}_{i}^{*} where {d}_{i}^{*} ( X ) = {( {x}_{i} - {x}_{i - 1} )}^{2} . \qquad ( 9 )$$

In general, if it is possible to define interpretable time series transformations {αₛ*} for values s≥0, where the definitions of the transformations differ only in the time interval −s≤t<0 that they are measured over, any non-negative linear combination of the αₛ* can be taken and interpreted as a recency-biased weighted transformation of the same type as αₛ*. In some examples, the families {αₛ*} are weighted averages, linear trend and intercept transformations, variance and mean-squared-change transformations. However, other transformations may be considered for other examples.

Families of time-series transformations can be used in the context of a machine learning model with monotonicity constraints to generate an explainable machine learning model. A first example is a machine learning model with a single linear activation function, such as a logistic regression model. For each time-series variable/data X, one or more families of transformations may be used to create independent variables for the machine learning model.

Given an observation of the time-series variable X for each observation in the modelling dataset, for each family of transformations {ƒᵢ*} to be applied to X, the values ƒᵢ*(X) can be calculated for all values of i in the indexing set of the family (which may or may not be the set of time values). The values ƒᵢ*(X) can then form independent variables for model fitting or training. By fitting a monotonically constrained model, a linear activation function can be obtained that includes a positive linear combination of the variables ƒᵢ*(X), that is:

$$V = {\sum }_{i} {a}_{i} {f}_{i}^{*} ( X ) + … where {a}_{i} \geq 0 \qquad ( 10 )$$

An interpretation may be applied to the term Σᵢαᵢƒᵢ*(X), for example, if {ƒᵢ*} are linear trend transformations for varying time windows ending at the observation point, then the term Σᵢαᵢƒᵢ*(X) may be interpreted as a recency weighted linear trend term.

If only one family of transformations is applied to X, the other terms in the activation function may be unrelated to X. If more than one family of transformations is applied to X, an activation function may be obtained of the form:

$$( 11 )$$

$$V = {\sum }_{i} {a}_{i} {f}_{{i}^{*}} ( X ) + {\sum }_{j} {b}_{j} {g}_{j}^{*} ( X ) + {\sum }_{k} {c}_{k} {h}_{k}^{*} ( X ) + … where {a}_{i} , {b}_{j} , {c}_{k} \geq 0$$

where {ƒᵢ*}, {gᵢ*} and {hₖ*} are different families of linear transformations applied to X. For example, {ƒᵢ*} may be linear trend transformations, {gᵢ*} may be recency biased average transformations and {hₖ*} may be mean squared change transformations. In this case, a different interpretation can be associated with each of the three terms, so Σᵢαᵢƒᵢ*(X) is interpreted as a recency weighted linear trend term as before, and Σⱼbⱼgⱼ*(X) is interpreted as a recency biased weighted average term.

When more than one family of transformations is applied to a single time series in the same linear activation function, transformations from multiple families may be linearly dependent or highly correlated. To mitigate these issues, a subset of time-series transformations may be selected, regularization may be performed, or group LASSO may be performed.

Selecting a subset of time-series transformations can remove linear dependence or reduce correlation via correlation analysis. Correlation analysis may be used to remove individual time-series transformations from within the families, or to remove whole families of transformations. If correlation analysis is applied at the level of families of transformations, the predictive power of each family may be measured by fitting or training a monotonically constrained logistic regression model using those variables alone, and the correlation measure may be any measure of mutual information, such as a generalized variance inflation factor (VIF) calculation based on the ratio of determinants of covariance matrices for the separate and combined families of transformations.

For regularization, regularization terms, including L1 and L2 norm penalty terms added to loss function, can be used to carry out automated variable selection or shrinkage in model fitting or training. If a function of X may be expressed in more than one way as a positive multiple of the time-series transformations, regularization can select the representation that minimizes the penalty term that is applied to the coefficients, allowing linearly dependent sets of independent variables to be used.

Group LASSO can be used to automatically select the most predictive famili(es) of transformations. Group LASSO has the effect of simultaneously shrinking the coefficients of all the variables in a specified group. In this case, a family of transformations can be treated as a group of variables.

Some monotonically constrained models, such as monotonically constrained neural network models, can use multiple linear combination activation functions based on the independent variables. Several strategies can be used to apply these models to families of time-series transformations. The strategies can include using one family of time-series transformations for each time series in each linear activation function, using multiple families of time-series transformations for each time series in each linear activation function, or performing regularization or group LASSO on each linear activation function to handle linear dependence or correlation between the families of time-series transformations.

Once a monotonically constrained model has been trained, each linear activation function in the model can include terms that are positive linear combinations of a family of time-series transformations. Each such term may be assigned an interpretation. Different linear activation functions may use different positive linear combinations of a given family of time-series transformations. For example, two nodes in a neural network model may detect two different recency weighted linear trend transformations. These can both be interpreted as trend transformations.

If this outcome is not desirable, each family of linear transformations, for each time series, can only appear in one linear activation function. One way to achieve this in a neural network model is to use one first layer node per family of transformations, per time series. Each of these nodes can then detect one explainable effect, based on one family of transformations applied to one time series.

Explanatory data can be generated using an explainable machine learning model that is monotonic in positive linear combinations of interpretable families of time-series transformations. A model scoring function can be used to generate the explanatory data. The model scoring function can be of the form:

$$F ( X , Y ) = F ( {a}_{i} {f}_{i}^{*} ( X ) , {b}_{j} {g}_{j}^{⋆} ( X ) , {c}_{k} {h}_{k}^{*} ( X ) , … , Y ) \qquad ( 12 )$$

where F is monotonically increasing in the values of the time-series transformations αᵢƒᵢ*(X), bⱼgⱼ*(X), cₖhₖ*(X), . . . and has no other dependency on the time series variable X. The goal is to explain a particular value of the risk indicator F (e.g., a risk score), by identifying the model variables which have the largest impact on the risk indicator in a particular decision situation. In credit risk modelling this information is often presented in the form of reason codes. In general, explanatory data in the form of reason codes can be generated for monotonic models by a points-below-max algorithm. For the points-below-max algorithm, for each independent variable x in the model, the difference between the current score and the score that would be obtained if x were replaced by its maximum value is calculated. The variable(s) that would yield the largest score increase(s) can be selected and reported as reasons why the calculated score is not higher.

For a model using interpretable families of time-series variables, the compound transformations of the form αᵢƒᵢ*(X) take the place of the independent variable in the model, for the purposes of creating model explanations. That is, to apply the points-below-max algorithm to the transformation αᵢƒᵢ*(X), the difference between the current score and the score that would be obtained if the current value of αᵢƒᵢ*(X) were replaced by its maximum value is calculated. The maximum value of αᵢƒᵢ*(X) can be calculated from the model development sample or a monitoring sample. If αᵢƒᵢ*(X) is chosen to generate a reason code, the interpretation assigned to αᵢƒᵢ*(X) is used. This approach is an extension of points-below-max that will be effective when the transformations αᵢƒᵢ*(X), bⱼgⱼ*(X), cₖhₖ*(X), . . . on X are not highly correlated.

If the transformations on time-series variable X are highly correlated (which can be measured from the model development sample), then it may not be reasonable to consider changing the value of one transformation alone. In this case, a generalized points-below-max approach can be used. The generalized points-below-max approach can involve treating a set of correlated time-series transformations (or more generally, correlated variables) as a group of variables. For a group of variables xₗ, . . . , xₖ, the difference between the current score and the maximum score that could be obtained by replacing xₗ, . . . , xₖ by alternative values can be calculated. The calculation can be done by generating a set of candidate values for the tuple (xₗ, . . . , xₖ) and testing each candidate value in turn. If the group of time-series transformations is chosen to generate a reason code, one interpretation may be returned as a reason if all of the transformations have a similar interpretation (e.g. trend). If the transformations have different interpretations, then a joint interpretation can be specified when the machine learning model is developed. For example, if weighted average and trend transformations for a time series are highly correlated, then an interpretation of ‘trend and value’ may be returned, or specifically ‘low value with decreasing trend’ may be expressed as desirable whereas ‘high value or increasing trend’ may be undesirable.

For a value of the tuple (xₗ, . . . , xₖ) to yield a maximum value of the model score (in the development sample or a modelling sample), no other value (xₗ′, . . . , xₖ′) can be present in the sample with xᵢ′≥xᵢ for all i, otherwise the model score value at (xₗ′, . . . , xₖ′) can be at least as high as at (xₗ, . . . , xₖ). Therefore, to develop a candidate set of values for a group of variables, values (xₗ, . . . , xₖ) can be selected that are maximal under the partial order on the coordinates. The set of candidate values may be further reduced by analysis of the model score function itself. The score function may be calculated for all candidate values, for a representative range of values of the other model variables. If a particular candidate value (xₗ′, . . . , xₖ) never yields the maximum score, it may be discarded from the candidate set.

Alternatively, or additionally, an integrated gradients algorithm may be used to generate the explanatory data. The integrated gradients algorithm can involve a reference point consisting of an alternative set of input variable values (X′, Y′), which produce an alternative score F(X′, Y′). The reference point can be chosen so that the score is above an acceptance threshold. Integrated gradients expresses the score difference F(X′, Y′)−F(X, Y) as a sum of contributions from each of the input variables in X′ and Y′ by evaluating an integral of the derivative of F over a path from (X, Y) to (X′,Y′).

Integrated gradients may be applied to a model with correlated input variables, including a model with multiple compound time-series transformations constructed as linear combinations of individual transformations. Treating each of the compound transformations as an input variable in its own right, the integrated gradients algorithm can be applied to express the score difference as a sum of contributions from each of the input variables, including the compound time-series transformations.

In some cases, the machine learning model used may be a generic monotonically constrained model that can yield a scoring function F that is a monotonic piecewise-differentiable function of its inputs, which include the families of time series transformations, but the scoring function may not necessarily factor through one or more linear combinations of the time series transformations. F is assumed to be monotonically non-decreasing in its inputs, as the inputs are expected to increase the score. In some cases it may be arranged that F is monotonically non-increasing in a subset of its inputs, where those inputs are expected to decrease the score. For a generic monotonically constrained model taking families of time series transformations ƒᵢ*(X) and gⱼ*(X) as inputs, the gradient with respect to the original time series input X=(xₜ, t≤0) can be derived to be:

$$( 13 )$$

$$\begin{matrix}∇ F = {\sum }_{i} \frac{\partial F}{\partial {f}_{i}^{⋆}} ∇ {f}_{i}^{⋆} + {\sum }_{j} \frac{\partial F}{\partial {g}_{j}^{⋆}} ∇ {g}_{j}^{⋆} = {\sum }_{i} {a}_{i} ∇ {f}_{i}^{⋆} + {\sum }_{j} {b}_{j} ∇ {g}_{j}^{⋆} \\ = ∇ [ {\sum }_{i} {a}_{i} {f}_{i}^{⋆} + {\sum }_{j} {b}_{j} {g}_{j}^{⋆} ]\end{matrix}$$

Here, V denotes the gradient with respect to X, and {αᵢ} and {bⱼ} are non-negative coefficients that vary over the input space, as they are the partial derivatives of F. So the gradient of F with respect to the time series X is equal to the gradient of a non-negative linear combination of the time-series transformations. In other words, the gradient of the scoring function F can be expressed as the sum of the gradients of one or more interpretable transformations of the time-series data that are justifiable as model effects. Locally, F behaves like a linear combination of interpretable transformations of the time-series data that are justifiable as model effects.

To generate model explanations for a generic monotonically constrained model, the integrated gradients method may be applied. Integrated gradients can express the score difference F(X′, Y′)−F(X, Y) between the given values of the input variables (X,Y) and a reference set of values (X′,Y′) as a sum of contributions from each of the input variables in X and Y by evaluating an integral of the derivative of F over a path from (X,Y) to (X′,Y′). Here X represents the time-series variable X=(xₜ, t≤0) and Y represents other inputs that do not depend on X.

As the time series X enters the scoring function F only through the families of time-series transformations (e.g., ƒᵢ*(X) and gⱼ*(X)), the integrated gradients calculation may be carried for each transformation. The integrated gradients calculation for an individual transformation ƒᵢ*(X) takes the form:

$$( 14 )$$

$${IG}_{{f}_{i}^{*}} = ( {f}_{i}^{*} ( {X}^{′} ) - {f}_{i}^{*} ( X ) ) {\int }_{0}^{1} \frac{\partial F ( ( X , Y ) + s ( {X}^{′} , {Y}^{′} ) - ( X , Y ) )}{\partial {f}_{i}^{*} ( X + s ( {X}^{′} - X ) )} ds = {a}_{i} ( {f}_{i}^{*} ( {X}^{′} ) - {f}_{i}^{*} ( X ) )$$

where the coefficient αᵢ is the integral, over a straight line path in the input space from (X,Y) to (X′,Y′), of the partial derivative of F with respect to the input ƒᵢ*(X). Since F is monotonically non-decreasing, this term is always non-negative. Hence, the integrated gradients calculation for ƒ(X) is a non-negative multiple of the change ƒᵢ*(X′)−ƒᵢ*(X) between the given input values and the reference point.

The contribution to the score difference F (X′, Y′)−F (X,Y) due to each of the time-series transformations ƒᵢ*(X) may be summed to yield a total contribution of the score difference due to the family of transformations ƒ*={ƒᵢ*(X)}, which can be expressed as:

$$( 15 )$$

$${IG}_{{f}_{i}^{*}} = {\sum }_{i} {IG}_{{f}_{i}^{*}} = {\sum }_{i} {a}_{i} ( {f}_{i}^{*} ( {X}^{′} ) - {f}_{i}^{*} ( X ) ) = {\sum }_{i} {a}_{i} {f}_{i}^{*} ( {X}^{′} ) - {\sum }_{i} {a}_{i} {f}_{i}^{*} ( X )$$

where the coefficients {αᵢ} again are non-negative integrals of the partial derivatives of F. Therefore, the contribution of the score difference F(X′,Y′)−F (X, Y) due to the family of time-series transformations ƒ*={ƒᵢ*(X)} may be expressed as the change in the compound operator Σᵢαᵢƒᵢ*(X). In other words, the family of time-series transformations may be expressed as the change in an interpretable transformation of the time-series data that is justifiable as a model effect.

Summing the calculations over multiple families of time-series transformations, using integrated gradients, the contribution to the score difference F (X′, Y′)−F (X, Y) due to the change in an input time series X may be expressed as a sum of changes in interpretable transformations of the time-series that are justifiable as model effects. The interpretations of these transformations, with their associated contributions to the score difference, may then be given as part of a model explanation.

### Example of Computing System for Machine-Learning Operations

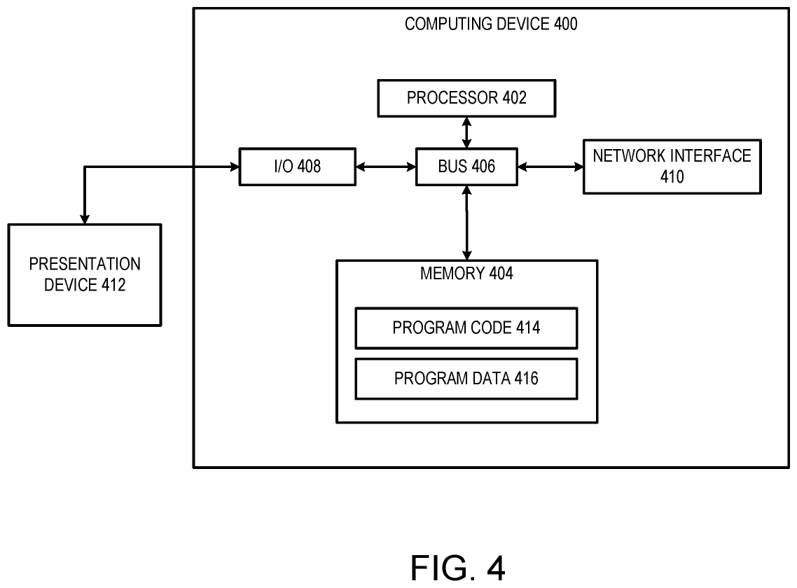

Any suitable computing system or group of computing systems can be used to perform the operations for the machine-learning operations described herein. For example, FIG. 4 is a block diagram depicting an example of a computing device 400, which can be used to implement the risk assessment server 118 or the network training server 110. The computing device 400 can include various devices for communicating with other devices in the operating environment 100, as described with respect to FIG. 1. The computing device 400 can include various devices for performing one or more transformation operations described above with respect to FIGS. 1-3.

The computing device 400 can include a processor 402 that is communicatively coupled to a memory 404. The processor 402 executes computer-executable program code stored in the memory 404, accesses information stored in the memory 404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 402 include a microprocessor, an application-specific integrated circuit, a field-programmable gate array, or any other suitable processing device. The processor 402 can include any number of processing devices, including one. The processor 402 can include or communicate with a memory 404. The memory 404 stores program code that, when executed by the processor 402, causes the processor to perform the operations described in this disclosure.

The memory 404 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 400 may also include a number of external or internal devices such as input or output devices. For example, the computing device 400 is shown with an input/output interface 408 that can receive input from input devices or provide output to output devices. A bus 406 can also be included in the computing device 400. The bus 406 can communicatively couple one or more components of the computing device 400.

The computing device 400 can execute program code 414 that includes the risk assessment application 114 and/or the network training application 112. The program code 414 for the risk assessment application 114 and/or the network training application 112 may be resident in any suitable computer-readable medium and may be executed on any suitable processing device. For example, as depicted in FIG. 4, the program code 414 for the risk assessment application 114 and/or the network training application 112 can reside in the memory 404 at the computing device 400 along with the program data 416 associated with the program code 414, such as the time-series data for predictor variables 124 and/or the neural network training samples 126. Executing the risk assessment application 114 or the network training application 112 can configure the processor 702 to perform the operations described herein.

In some aspects, the computing device 400 can include one or more output devices. One example of an output device is the network interface device 410 depicted in FIG. 4. A network interface device 410 can include any device or group of devices suitable for establishing a wired or wireless data connection to one or more data networks described herein. Non-limiting examples of the network interface device 410 include an Ethernet network adapter, a modem, etc.

Another example of an output device is the presentation device 412 depicted in FIG. 4. A presentation device 412 can include any device or group of devices suitable for providing visual, auditory, or other suitable sensory output. Non-limiting examples of the presentation device 412 include a touchscreen, a monitor, a speaker, a separate mobile computing device, etc. In some aspects, the presentation device 412 can include a remote client-computing device that communicates with the computing device 400 using one or more data networks described herein. In other aspects, the presentation device 412 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A method that includes one or more processing devices performing operations comprising:
accessing time-series data of a predictor variable associated with a target entity, the time-series data comprising data instances of the predictor variable at a sequence of time points;
generating a first set of transformed time-series data instances by applying a first family of transformations on the time-series data;
generating a second set of transformed time-series data instances by applying a second family of transformations on the time-series data;
determining a risk indicator for the target entity indicating a level of risk associated with the target entity by inputting at least the first set of transformed time-series data instances and the second set of transformed time-series data instances into a machine learning model, wherein the machine learning model determines the risk indicator based on transformed time-series data instances such that a monotonic relationship exists between each transformed time-series data instance and the risk indicator; and
transmitting, to a remote computing device, a responsive message including the risk indicator that is usable for controlling access to one or more interactive computing environments by the target entity.

2. The method of claim 1, wherein the first family of transformations or the second family of transformations comprises: a family of linear transformations or a family of non-linear transformations.

3. The method of claim 2, wherein the family of linear transformations comprises a family of linear transformations enforcing a recency bias on the time-series data or a family of transformations to obtain trends or projections in the time-series data based on a linear regression; and wherein the family of non-linear transformations comprises a family of variance, volatility, or mean squared change transformations.

4. The method of claim 1, wherein the operations further comprise:
generating, for the target entity, explanatory data using the machine learning model indicating relationships between changes in the risk indicator and changes in at least some transformed time-series data instances of the first set of transformed time-series data instances or the second set of transformed time-series data instances.

5. The method of claim 4, wherein the explanatory data is generated by using a points-below-max algorithm or an integrated gradients algorithm.

6. The method of claim 1, wherein the machine learning model is trained by a training process comprising: reducing correlation among the first set of transformed time-series data instances and the second set of transformed time-series data instances by performing correlation analysis, regularization, or group least absolute shrinkage and selection operator (LASSO) on at least the first family of transformations and the second family of transformations.

7. The method of claim 1, wherein the machine learning model is a neural network model; the first set of transformed time-series data instances are fed into a first hidden node in a first hidden layer of the neural network model; and the second set of transformed time-series data instances are fed into a second hidden node in the first hidden layer of the neural network model.

8. A system comprising:
a processing device; and
a memory device in which instructions executable by the processing device are stored for causing the processing device to perform operations comprising:
accessing time-series data of a predictor variable associated with a target entity, the time-series data comprising data instances of the predictor variable at a sequence of time points;
generating a first set of transformed time-series data instances by applying a first family of transformations on the time-series data;
generating a second set of transformed time-series data instances by applying a second family of transformations on the time-series data;
determining a risk indicator for the target entity indicating a level of risk associated with the target entity by inputting at least the first set of transformed time-series data instances and the second set of transformed time-series data instances into a machine learning model, wherein the machine learning model is configured to determine the risk indicator based on transformed time-series data instances such that a monotonic relationship exists between each transformed time-series data instance and the risk indicator; and
transmitting, to a remote computing device, a responsive message including the risk indicator, wherein the risk indicator is usable for controlling access to one or more interactive computing environments by the target entity.

9. The system of claim 8, wherein the first family of transformations or the second family of transformations comprises: a family of linear transformations or a family of non-linear transformations.

10. The system of claim 9, wherein the family of linear transformations comprises a family of linear transformations for enforcing a recency bias on the time-series data or a family of transformations to obtain trends or projections in the time-series data based on a linear regression; and wherein the family of non-linear transformations comprises a family of variance, volatility, or mean squared change transformations.

11. The system of claim 8, wherein the operations further comprise:
generating, for the target entity, explanatory data using the machine learning model indicating relationships between changes in the risk indicator and changes in at least some transformed time-series data instances of the first set of transformed time-series data instances or the second set of transformed time-series data instances.

12. The system of claim 11, wherein the explanatory data is generated by using a points-below-max algorithm or an integrated gradients algorithm.

13. The system of claim 8, wherein the machine learning model is trainable by a training process comprising: reducing correlation among the first set of transformed time-series data instances and the second set of transformed time-series data instances by performing correlation analysis, regularization, or group least absolute shrinkage and selection operator (LASSO) on at least the first family of transformations and the second family of transformations.

14. The system of claim 8, wherein the machine learning model is a neural network model having a first hidden layer comprising:
a first hidden node configured to receive the first set of transformed time-series data instances; and
a second hidden node configured to receive the second set of transformed time-series data instances.

15. A non-transitory computer-readable storage medium having program code that is executable by a processor device to cause a computing device to perform operations, the operations comprising:
accessing time-series data of a predictor variable associated with a target entity, the time-series data comprising data instances of the predictor variable at a sequence of time points;
generating a first set of transformed time-series data instances by applying a first family of transformations on the time-series data;
generating a second set of transformed time-series data instances by applying a second family of transformations on the time-series data;
determining a risk indicator for the target entity indicating a level of risk associated with the target entity by inputting at least the first set of transformed time-series data instances and the second set of transformed time-series data instances into a machine learning model, wherein the machine learning model is configured to determine the risk indicator based on transformed time-series data instances such that a monotonic relationship exists between each transformed time-series data instance and the risk indicator; and
transmitting, to a remote computing device, a responsive message including the risk indicator, wherein the risk indicator is usable for controlling access to one or more interactive computing environments by the target entity.

16. The non-transitory computer-readable storage medium of claim 15, wherein the first family of transformations or the second family of transformations comprises: a family of linear transformations or a family of non-linear transformations.

17. The non-transitory computer-readable storage medium of claim 16, wherein the family of linear transformations comprises a family of linear transformations for enforcing a recency bias on the time-series data or a family of transformations to obtain trends or projections in the time-series data based on a linear regression; and wherein the family of non-linear transformations comprises a family of variance, volatility, or mean squared change transformations.

18. The non-transitory computer-readable storage medium of claim 15, wherein the operations further comprise:
generating, for the target entity, explanatory data using the machine learning model indicating relationships between changes in the risk indicator and changes in at least some transformed time-series data instances of the first set of transformed time-series data instances or the second set of transformed time-series data instances.

19. The non-transitory computer-readable storage medium of claim 18, wherein the explanatory data is configured to be generated by using a points-below-max algorithm or an integrated gradients algorithm.

20. The non-transitory computer-readable storage medium of claim 15, wherein the machine learning model is trainable by a training process comprising: reducing correlation among the first set of transformed time-series data instances and a second set of transformed time-series data instances generated by applying a second family of transformations on the time-series data by performing correlation analysis, regularization, or group least absolute shrinkage and selection operator (LASSO) on at least the first family of transformations and the second family of transformations.
